(19) United States
(12) Patent Application Publication
(10) Pub. No.: US 2008/0019561 A1
(43) Pub. Date: Jan. 24, 2008

(54) Printing system, printer, printing method, reader, and reading method

(76) Inventors: Kazuo Tani, Chiba-shi (JP); Moriyoshi Shoji, Chiba-shi (JP)

Correspondence Address: BRUCE L. ADAMS, ESQ., SUITE 1231, 17 BATTERY PLACE, NEW YORK, NY, 10004, US

(21) Appl. No.: 11/805,689

(22) Filed: May 24, 2007

(30) Foreign Application Priority Data
Jul. 24, 2006 (JP) 2006-200344

(51) Int. Cl. G06K 9/00

(52) U.S. Cl. 382/100

(57) ABSTRACT

Provided is a printing system, a printer, and a printing method with which decoding of digital watermarks is possible at a high ratio while ensuring visibility of human-readable information even when the human-readable information is superimposed on the digital watermarks before printing. In a URL server (2), a conversion unit (22) converts predetermined information into digital watermark information represented by a plurality of dots in an on state among dots arranged in a matrix manner, a processing unit (23) generates thinned-out digital watermark information by processing a part of the plurality of dots in the on state into dots in an off state so that at least dots that are successively arranged in a vertical or horizontal direction and are in the on state are not present in the digital watermark information, and a communication control unit (24) transmits the thinned-out digital watermark information to a printer (3). The printer (3) prints the thinned-out digital watermark information and the human-readable information in a superimposed manner.

### BACKGROUND OF THE INVENTION

1. Field of the Invention

The present invention relates to a printing system, a printer, a printing method, a reader, and a reading method, and more particularly, to a printing system, a printer, a printing method, a reader, and a reading method for printing an image having a digital watermark embedded therein.

2. Description of the Related Art

Up to now, there is known a printing device for printing information indicated by a character and the like represented in a form recognizable by a person (hereinafter, referred to as “human-readable information”) and a digital watermark such that the human-readable information is superimposed on the digital watermark.

JP 2003-196744 A discloses a receipt issuing device for printing, on a receipt, information on a product represented by human-readable information and digital watermark data generated from information unique to the product such that the human-readable information is superimposed on the digital watermark data, and issuing the receipt.

As a printing device for printing a receipt or for printing a label, a thermal printer of a thermal recording system is used in many cases. In the case of printing device, most of printed output images are monochromatic images. For this reason, the human-readable information and the digital watermark are often printed in black and white. In this case, as shown in FIG. 18, when outlines of characters which correspond to human-readable information are superimposed on a background image which is digital watermark information, the outlines of the characters blur. As a result, the human-readable information is made hardly visible. In other words, the human-readable information is made hardly visible in some cases due to the digital watermark.

JP 2006-130801 A discloses a printing device capable of preventing the human-readable information from being hardly visible due to the digital watermark. Specifically, as shown in FIG. 19, in the printing device, a void region (hollow region) 19A is provided to the digital watermark, and the human-readable information is printed within the outlined region.

Further, JP 2006-130801 A discloses a technique of adjusting a gradation of an image to make the human-readable information visible more easily. Specifically, an area gradation method in which a dot area ratio within an area element is disclosed as the method of adjusting the gradation of an image.

In a case where the area gradation is performed in digital form, a pixel is generally formed using binary dots.

FIG. 20 is a diagram for explaining the area gradation method. In FIG. 20, a dot having a small area within an area element 63 is associated with one binary dot provided within an area element 64, a dot having a middle-size area within an area element 65 is associated with three binary dots provided within an area element 66, and further a dot having a large area within an area element 67 is associated with nine binary dots provided within an area element 68.

The printing device described in JP 2006-130801 A stores a correspondence between the area gradation and the binary dots, and decides arrangement of the binary dots according to the set gradation. Note that FIG. 20 is merely a schematic diagram, and there are various correspondences between the area gradation and the arrangement of the binary dots.

As in the receipt issuing device described in JP 2003-196744 A, when the human-readable information is superimposed on the digital watermark before printing without performing any processing, there is a possibility that the human-readable information is hardly visible due to the digital watermark.

In addition, in the printing device according to JP2006-130801 A, since there is the outlined region of the digital watermark, there is a possibility that the digital watermark information is excessively lost, which may make it difficult to decode the original information based on the digital watermark. Further, even in the case where the area gradation method is performed with respect to the digital watermark as shown in FIG. 20, when the digital watermark, which has been subjected to the area gradation, and a character are printed such that the character is superimposed on the digital watermark, the outline of the character blurs. As a result, the character may be made hardly visible.

### SUMMARY OF THE INVENTION

It is an object of the present invention to provide a printing system, a printer, a printing method, a reader, and a reading method capable of decoding digital watermarks at a high possibility while ensuring visibility of human-readable information even when the human-readable information is superimposed on the digital watermarks before printing.

In order to achieve the above-mentioned object, according to an aspect of the present invention, there is provided a printing system including: a transmission device for transmitting digital watermark information; and a printer for printing the digital watermark information transmitted from the transmission device and human-readable information including one of a character and an image such that the human-readable information is superimposed on the digital watermark information, in which: the transmission device includes: a conversion unit for converting predetermined information into digital watermark information represented by a plurality of dots that are arranged in a matrix manner and are in an on state; a processing unit for generating thinned-out digital watermark information by processing a part of the plurality of dots in the on state into dots in an off state so that at least dots that are successively arranged in a vertical or horizontal direction and are in the on state are not present in the digital watermark information converted by the conversion unit; and a transmission unit for transmitting the thinned-out digital watermark information generated in the processing unit to the printer; and the printer includes: a reception unit for receiving the thinned-out digital watermark information from the transmission unit; a storage unit for storing the thinned-out digital watermark information received by the reception unit; an acceptance unit for accepting the human-readable information; and a printing execution unit for printing the thinned-out digital watermark information stored in the storage unit and the human-readable information accepted by the acceptance unit such that the human-readable information is superimposed on the thinned-out digital watermark information.

It should be noted that the dots in the on state indicate dots that are to be subjected to actual printing, and the dots in the off state indicate dots that are not to be subjected to actual printing.

According to another aspect of the present invention, there is provided a printing method for a printing system including a transmission device for transmitting digital watermark information and a printer for printing the digital watermark information transmitted from the transmission device and human-readable information including one of a character and an image such that the human-readable information is superimposed on the digital watermark information, the method including): a converting step of converting, by the transmission device, predetermined information into digital watermark information represented by a plurality of dots that are arranged in a matrix manner and are in an on state; a processing step of generating, by the transmission device, thinned-out digital watermark information by processing a part of the plurality of dots in the on state into dots in an off state so that at least dots that are successively arranged in a vertical or horizontal direction and are in the on state are not present in the digital watermark information; a transmitting step of transmitting, by the transmission device, the thinned-out digital watermark information to the printer; a receiving step of receiving, by the printer, the thinned-out digital watermark information from the transmission unit; a storing step of storing, by the printer, the received thinned-out digital watermark information; an accepting step of accepting, by the printer, the human-readable information; and a printing execution step of printing, by the printer, the stored thinned-out digital watermark information and the accepted human-readable information such that the human-readable information is superimposed on the thinned-out digital watermark information.

According to another aspect of the present invention, there is provided a printer for printing digital watermark information and human-readable information including one of a character and an image such that the human-readable information is superimposed on the digital watermark information, including: a data storage unit for storing digital watermark information represented by a plurality of dots in an on state among dots arranged in a matrix manner; a processing unit for generating thinned-out digital watermark information by processing a part of the plurality of dots in the on state into dots in an off state so that at least dots that are successively arranged in a vertical or horizontal direction and are in the on state are not present in the digital watermark information stored in the data storage unit; a storage unit for storing the thinned-out digital watermark information generated in the processing unit; an acceptance unit for accepting the human-readable information; and a printing execution unit for printing the thinned-out digital watermark information stored in the storage unit and the human-readable information accepted by the acceptance unit such that the human-readable information is superimposed on the thinned-out digital watermark information.

According to another aspect of the present invention, there is provided a printing method for a printer, including printing digital watermark information and human-readable information including one of a character and an image such that the human-readable information is superimposed on the digital watermark information, the method including: a data storing step of storing digital watermark information represented by a plurality of dots in an on state among dots arranged in a matrix manner; a processing step of processing a part of the plurality of dots in the on state into dots in an off state so that at least dots that are successively arranged in a vertical or horizontal direction and are in the on state are not present in the digital watermark information, to produce thinned-out digital watermark information; a storing step of storing the thinned-out digital watermark information; an accepting step of accepting the human-readable information; and a printing execution step of printing the stored thinned-out digital watermark information and the accepted human-readable information such that the human-readable information is superimposed on the thinned-out digital watermark information.

According to the present invention, a part of the plurality of dots in the on state representing the digital watermark information are processed into dots in the off state so that at least dots that are successively arranged in a vertical or horizontal direction and are in the on state are not present in the digital watermark information, to thereby generate thinned-out digital watermark information, and the human-readable information is superimposed on the thinned-out digital watermark information before printing.

For this reason, the digital watermark information is made more invisible than one in the state before the dots are thinned out. As a result, visibility of the human-readable information is improved. In addition, since the dots are thinned out so that at least dots that are successively arranged in a vertical or horizontal direction are not present in the digital watermark information, a rough shape of the digital watermark information can be maintained, and thus the digital watermark information can be decoded at a high ratio.

It is preferable that the printing execution unit print the thinned-out digital watermark information using a color different from that used for the human-readable information.

According to the present invention, it is possible to prevent the human-readable information from being hardly visible due to the digital watermark information.

Further, the printing execution unit preferably includes: an analysis unit for analyzing the human-readable information; a human-readable information processing unit for processing the human-readable information based on analysis results of the analysis unit; and a printing unit for printing the human-readable information processed by the human-readable information processing unit and the thinned-out digital watermark information stored in the storage unit such that the human-readable information is superimposed on the thinned-out digital watermark information.

According to the present invention, it is possible to process the human-readable information according to forms of the human-readable information. For this reason, for example, it is possible to process the human-readable information, which is hardly visible when the human-readable information is superimposed on the digital watermark information, into a form which becomes hardly invisible even when the human-readable information is superimposed on the digital watermark information.

Further, according to another aspect of the present invention, there is provided a reader for reading digital watermark information, including: an image taking unit for taking an image of the digital watermark information and outputting digital watermark image information; a smoothing unit for smoothing the digital watermark image information outputted from the image taking unit; and an output unit for outputting the digital watermark image information smoothed by the smoothing unit.

According to another aspect of the present invention, there is provided a reading method for a reader for reading digital watermark information, including: an image taking step of taking an image of the digital watermark information and outputting digital watermark image information; a smoothing step of smoothing the digital watermark image information; and an outputting step of outputting the smoothed digital watermark image information.

According to the present invention, image information corresponding to the digital watermark information from which dots are thinned out can be changed to a state approximate to a state before the dots are thinned out. As a result, for example, the digital watermark information which is superimposed on the human-readable information before printing by the printing system or the printer can be decoded at a high ratio.

According to the present invention, a part of the plurality of dots in the on state representing the digital watermark information is processed into dots in the off state so that at least dots that are successively arranged in a vertical or horizontal direction and are in the on state are not present in the digital watermark information, to thereby generate thinned-out digital watermark information, and the human-readable information is superimposed on the thinned-out digital watermark information before printing.

Therefore, the digital watermark information is made more invisible than one in the state before the dots are thinned out, and thus the visibility of the human-readable information is improved. In addition, since the dots are thinned out so that at least dots that are successively arranged in a vertical or horizontal direction are not present in the digital watermark information, a rough shape of the digital watermark information can be maintained, and thus the digital watermark information can be decoded at a high ratio.

### BRIEF DESCRIPTION OF THE DRAWINGS

In the accompanying drawings:

FIG. 1 is a diagram for explaining an outline of an embodiment of the present invention;

FIG. 2 is a diagram for explaining the outline of the embodiment of the present invention;

FIG. 3 is a block diagram showing a configuration of an information providing system 1 according to the embodiment shown in FIG. 1;

FIG. 4 is a diagram showing an example of a logical configuration of an ID database provided to a URL server 2 of FIG. 2;

FIG. 5 is an explanatory diagram showing an example of a receipt on which an ID background image is printed;

FIG. 6 is a block diagram showing a configuration of a printer 3;

FIG. 7 is a block diagram showing the configuration of the printer 3;

FIG. 8 is a flowchart showing operations of the printer 3;

FIG. 9 is a diagram for explaining an example of processing of human-readable information;

FIG. 10 is an explanatory diagram showing an example where processed human-readable information is superimposed on a thinned image before printing;

FIG. 11 is a block diagram showing a configuration of a cellular phone 5;

FIGS. 12A and 12B are explanatory diagrams each showing an example of a screen displayed on the cellular phone relating to taking an image of a receipt;

FIG. 13 is a flowchart showing a procedure for connecting the cellular phone 5 to a service server 6;

FIG. 14 is a block diagram showing a configuration of a printer 30;

FIG. 15 a diagram for explaining an example of thinning-out processing;

FIG. 16 is an explanatory diagram showing an example where processed human-readable information is superimposed on a thinned image before printing;

FIG. 17 is an explanatory diagram showing an example where the processed human-readable information is superimposed on the thinned image before printing;

FIG. 18 is an explanatory diagram showing an example of conventional printing;

FIG. 19 is an explanatory diagram showing an example of the conventional printing; and

FIG. 20 is a diagram for explaining a conventional method of performing half-toning.

### DETAILED DESCRIPTION OF THE PREFERRED EMBODIMENTS

### (1) Outline of Embodiment

A printing system according to an embodiment of the present invention includes a transmission device and a printer. The transmission device transmits digital watermark information to the printer, and the printer prints the digital watermark information transmitted from the transmission device and human-readable information including characters or images such that the human-readable information is superimposed on the digital watermark information.

The transmission device defines specific information (predetermined information) in a frequency domain, and subjects the specific information to inverse Fourier transform (distribution) The specific information contains character information, image information, or, for example, ID pattern information associated with a uniform resource locators (URL) of a certain website. Hereinafter, the ID pattern information is used as the specific information.

The transmission device defines the specific information, and subjects the specific information to inverse Fourier transform, thereby generating digital watermark information (distributed image; hereinafter, referred to as “ID background image”) which is a pattern having the ID pattern distributed over an entire screen. In this embodiment, the ID background image is represented by a plurality of dots in an on state among dots arranged in a matrix manner.

The transmission device generates thinned image (thinned digital watermark information) by processing apart of the plurality of dots in the on state into dots in an off state so that at least dots that are successively arranged in a vertical or horizontal direction and are in the on state are not present in the ID background image. It should be noted that the dots in the on state indicate dots that are to be subjected to actual printing, and the dots in the off state indicate dots that are not to be subjected to actual printing.

The transmission device transmits the thinned image to the printer.

The printer receives the thinned image transmitted from the transmission device and stores the thinned image.

The printer prints the thinned image and human-readable information constituted of a character, an image (pattern), and the like such that the human-readable information is superimposed on the thinned image.

In a part of the thinned image on which the human-readable information is printed, the thinned image is lost, but the ID pattern of this part can be restored by subjecting the pattern of the remaining part of the thinned image to Fourier transform.

In this embodiment, an image of a print medium (e.g., receipt) on which the human-readable information is superimposed on the thinned image before printing is taken using a camera of a cellular phone, and the photographed image data is transmitted to the URL server from the cellular phone.

The URL server receives the photographed image data from the cellular phone, and subjects the photographed image data to Fourier transform to thereby extract the ID pattern.

The URL server stores ID patterns and URLs in advance by associating them with each other, retrieves the URL associated with the extracted ID pattern, and transmits the URL to the cellular phone.

The cellular phone receives the URL from the URL server, is connected to the website designated by the URL, and utilizes services provided by the website.

As described above, in this embodiment, the URL is associated with the print medium through the ID background image.

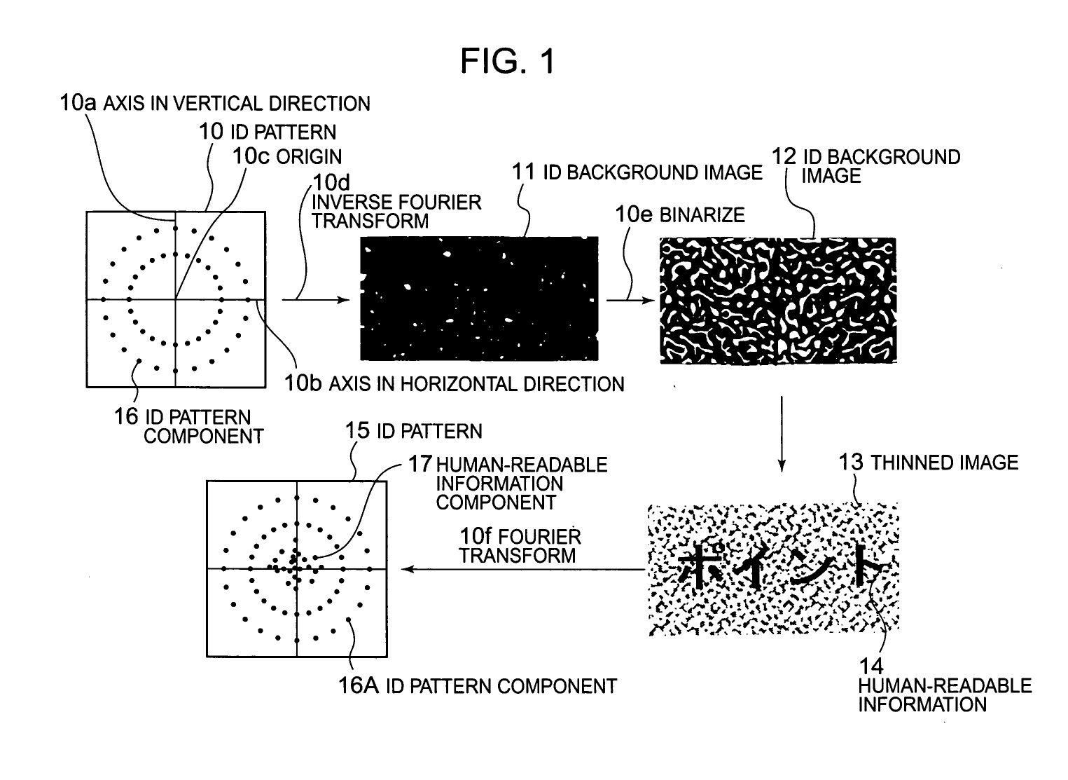

FIG. 1 is a diagram for explaining the outline of this embodiment.

First, distribution (inverse Fourier transform) of the ID pattern and decoding (Fourier transform) of the distributed ID pattern will be described.

First, an ID pattern 10 is defined in a frequency domain. The ID pattern 10 includes ID pattern components 16 which are dots distributed on an inner periphery and an outer periphery. The closer to an origin 10c of an axis 10a in a vertical direction and an axis 10b in a horizontal direction, the lower the frequency side. The farther from the origin 10c, the higher the frequency.

When the ID pattern 10 is subjected to inverse Fourier transform, an ID background image 11 is obtained in a real space. The ID background image 11 has a pattern scattered (distributed) over the entire image.

In a case of specifying the ID pattern 10, it is preferable to select a pattern in which the ID background image 11 obtained after being subjected to inverse Fourier transform as described above is distributed over the enter image.

When the ID pattern 10 is subjected to inverse Fourier transform, the ID background image 11 can be obtained. To the contrary, when the ID background image 11 is subjected to Fourier transform, the ID pattern 10 can be obtained.

In this manner, when an appropriate ID pattern is selected to be subjected to inverse Fourier transform, information used for restoring the ID pattern is distributed over the entire ID background image 11, and a resistance to processing such as compression or cutting is generated.

In other words, since the information used for specifying the ID pattern is distributed over the entire image, it is possible to restore the ID pattern based on the information remained in the image even when the image is enlarged, reduced, or partially cut.

In this embodiment, the ID background image 11 is binarized so as to be printed by a small printing device such as a receipt printing mechanism for a cash register, to thereby generate an ID background image 12. The ID background image 12 is represented by a plurality of dots in the on state among the dots arranged in a matrix manner.

After that, a part of the plurality of dots in the on state is processed into dots in the off state so that at least dots that are successively arranged in a vertical or horizontal direction and are in the on state are not present in the ID background image 12, to thereby generate a thinned image 13, and human-readable information 14 including a character string representing [symbol] is superimposed on the thinned image 13 before printing.

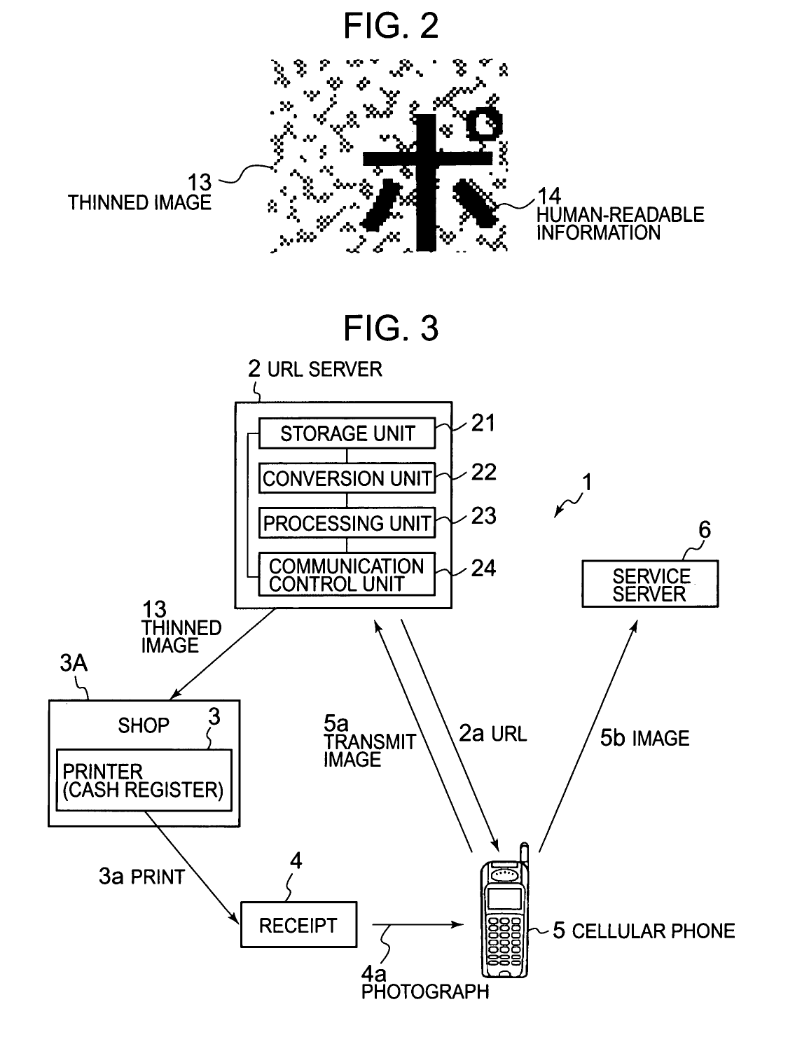

FIG. 2 is a partially enlarged view of a printed result obtained such that the thinned image 13 is superimposed on the human-readable information 14 before printing.

A camera takes an image of the printed result obtained such that the thinned image 13 is superimposed on the human-readable information 14 before printing, and generates digital image data. When the digital image data is subjected to Fourier transform, the ID pattern 15 can obtained.

In the ID pattern 15, ID pattern components 16A are restored and frequency components 17 corresponding to the human-readable information 14 are formed. The frequency components 17 corresponding to the human-readable information 14 are likely to be distributed heavily on a lower frequency side. As a result, it is possible to discriminate the frequency components 17 from the ID pattern components 16A, and extract the ID pattern components 16A.

As described above, the restored ID pattern components 16A are extracted from the ID pattern 15, and a coincidence between the ID pattern components 16A and the ID pattern components 16 of the ID pattern 10 is checked. Accordingly, it is possible to identify the ID pattern contained in a printed material.

### (2) Detailed Embodiment

FIG. 3 is a block diagram showing a configuration of an information providing system 1 including the printing system according to this embodiment.

The information providing system 1 includes a URL server 2, a printer 3, a receipt 4, a cellular phone (reader) 5, and a service server 6. The printing system includes the URL server 2 and the printer 3.

In FIG. 3, one printer 3 and one cellular phone 5 are shown, but a plurality of printers and cellular phones may be provided.

The URL server 2 is an example of the transmission device, and includes a storage unit 21, a conversion unit 22, a processing unit 23, and a communication control unit 24.

The storage unit 21 stores an ID database including a plurality of ID patterns 10 and URL data associated with each of the plurality of ID patterns 10.

The conversion unit 22 subjects the ID patterns stored in the storage unit 21 to inverse Fourier transform to generate data of the ID background image 11. The ID background image 11 is represented by a plurality of dots in the on state among dots arranged in a matrix manner. The conversion unit 22 binarizes the ID background image 11, generates the ID background image 12, and provides the generated ID background image 12 to the processing unit 23.

Upon reception of the ID background image 12, the processing unit 23 processes a part of the plurality of dots in the on state into dots in an off state so that at least dots that are successively arranged in a vertical or horizontal direction and are in the on state are not present in the ID background image 12, to thereby generate the thinned image 13.

For example, the processing unit 23 switches the state of the successive dots, that are in the on state in the ID background image 12, to the on state and the off state alternately, so that the dots in the on states make a checkered pattern. The processing performed by the processing unit 23 is not limited to the above-mentioned processing, but may be appropriately changed. For example, the processing unit 23 may process the ID background image 12 so that two successive dots in the off state are present in adjacent dots in the on state. The image data is thus processed.

The processing unit 23 provides the thinned image 13 to the communication control unit 24.

The communication control unit 24 receives the data of the thinned image 13 from the processing unit 23, and transmits the data of the thinned image 13 to the printer 3.

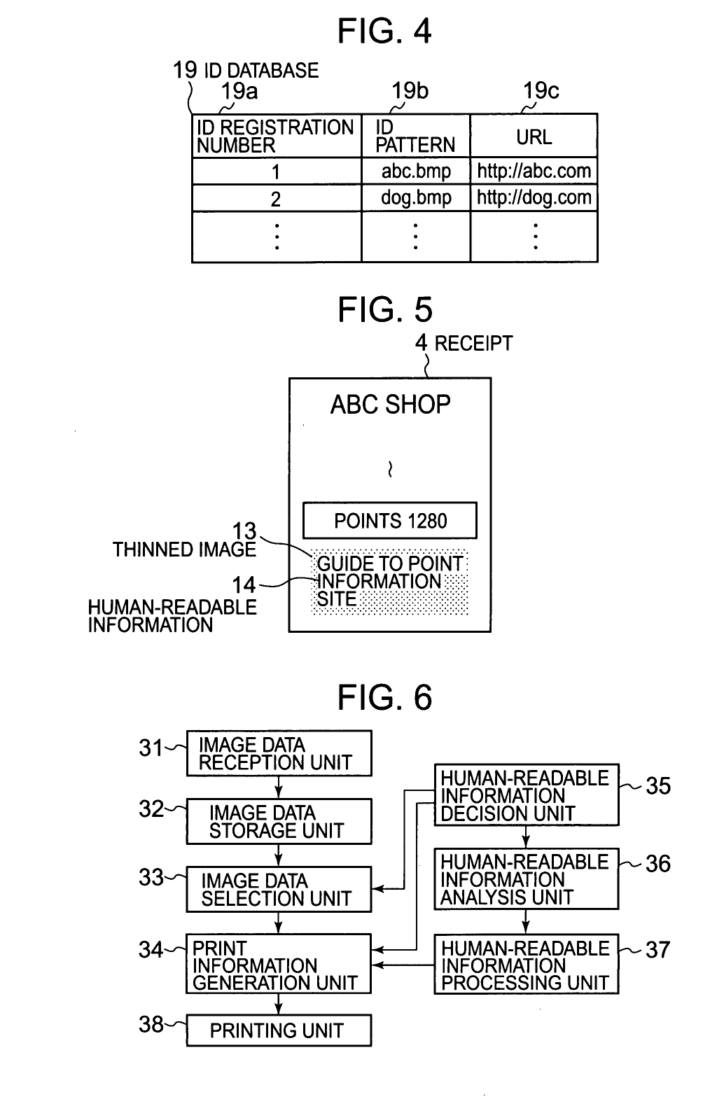

FIG. 4 is a diagram showing an image of a logical configuration of ID database to be stored in the storage unit 21.

In FIG. 4, an ID database 19 includes items of an ID registration number 19a, an ID pattern 19b, and a URL 19c.

The ID registration number 19a is a management number for managing the ID pattern 19b and the URL 19c, and is uniquely given to each pair of the ID pattern 19b and the URL 19c.

The ID pattern 19b stores imaged at a for defining the ID pattern, for example, data of the ID pattern 10 shown in FIG. 1.

The URL 19c stores URL information which is connection information for establishing connection to a certain website.

The ID database 19 stores the ID patterns 19b and the URLs 19c being associated with each other. When the ID pattern 19b is specified, the corresponding URL 19c is obtained.

Next, a function of providing a thinned image to the printer 3 by the URL server 2 will be described.

The URL server 2 and the printer 3 are arranged to be connectable to each other via, for example, a network such as the Internet, and the URL server 2 provides ID information, in a form of thinned image, to the printer 3 via the network.

In this embodiment, the URL server 2 subjects the ID pattern to inverse Fourier transform to generate data of the ID background image, and further binarizes the data of the ID background image. After that, the URL server 2 generates thinned image data by thinning out the dots and transmits the thinned image data to the printer 3.

As described above, when the URL server 2 transmits the thinned image data to the printer 3, image processing performed by the printer 3 can be eliminated, and the amount of data to be transmitted to the printer 3 by the URL server 2 can be reduced.

The above-mentioned case is an example, and alternatively, for example, the printer 3 may be provided with the storage unit 21, the conversion unit 22, and the processing unit 23, and the URL server 2 may transmit the ID pattern to the printer 3. Then, in the printer 3, data of the ID pattern image may be subjected to inverse Fourier transform to generate ID background image data, the ID background image data may be binarized, and the binarized ID background image data may be thinned out in the above-mentioned manner to thereby generate the thinned image data. Alternatively, the printer 3 may be provided with a part of each of the storage unit 21, the conversion unit 22, and the processing unit 23.

Next, a function of providing a URL to the cellular phone 5 by the URL server 2 will be described.

The URL server 2 receives the photographed image data obtained by taking an image of the receipt 4 using the cellular phone 5 via a network such as the Internet.

The receipt 4 is a print medium to be printed by the printer 3. An outer appearance thereof is shown in FIG. 5. That is, the human-readable information 14 (in this case, a character string indicating “Guide to point information site”) is printed on the receipt 14 with the thinned image 13 as a background.

The communication control unit 24 of the URL serer 2 receives the photographed image data from the cellular phone 5 and subjects the photographed image data to Fourier transform to restore the ID pattern.

Then, the communication control unit 24 extracts the restored ID pattern and checks the extracted ID pattern against the ID pattern stored in the ID database 19 of the storage unit 21.

The communication control unit 24 transmits the URL associated with the ID pattern specified through the checking, to the cellular phone 5.

In this embodiment, the URL server 2 subjects the photographed image to Fourier transform to extract the ID pattern, but the cellular phone 5 may subject the photographed image to Fourier transform to extract the ID pattern and may transmit the ID pattern to the URL server 2.

In the case where the URL server 2 extracts the ID pattern, it is unnecessary for the cellular phone 5 to have an image processing function of extracting the ID pattern, which can reduce a load on the cellular phone 5.

On the other hand, in the case where the cellular phone 5 extracts the ID pattern, the URL server 2 does not receive transmission of the photographed image data due to a failure of taking an image by the cellular phone 5, and the URL server 2 does not have to perform image processing, thereby making it possible to reduce a load on the URL server 2.

Next, the printer 3 will be described. The printer 3 is, for example, a cash register installed in a checkout area of a shop, and has a checkout function and a receipt printing function.

FIG. 6 is a block diagram showing an example of a functional configuration of the printer 3.

In FIG. 6, the printer 3 includes an image data reception unit 31, an image data storage unit 32, an image data selection unit 33, a print information generation unit 34, a print information decision unit 35, a human-readable information analysis unit 36, a human-readable information processing unit 37, and a printing unit 38.

The image data reception unit 31 is an example of a reception unit, the image data storage unit 32 is an example of a storage unit, the human-readable information decision unit 35 is an example of a reception unit, and the human-readable information analysis unit 36 is an example of an analysis unit.

Further, a printing execution unit is composed of the image data selection unit 33, the print information generation unit 34, the human-readable information analysis unit 36, the human-readable information processing unit 37, and the printing unit 38. A print unit is composed of the image data selection unit 33, the print information generation unit 34, and the printing unit 38.

The image data reception unit 31 includes connection information to the URL server 2, and is connected to the URL server 2 via the network to receive the thinned image data from the URL server 2.

The printer 3 may request the ID registration number to the URL server 2, and the URL server 2 may transmit to the printer 3 the thinned image data corresponding to the requested ID registration number. Alternatively, the URL server 2 may decide the thinned image data to be transmitted to the printer 3.

The image data storage unit 32 is constituted by using, for example, a storage medium such as a hard disk or a semiconductor memory, and stores the thinned image data which has been received by the image data reception unit 31 from the URL server 2.

The image data storage unit 32 can store a plurality of pieces of thinned image data, and each piece of the thinned image data stored in the image data storage unit 32 can be discriminated by the ID registration number corresponding to the thinned image data.

The image data selection unit 33 selects the thinned image data to be printed from the thinned image data stored in the image data storage unit 32 when the receipt 4 is printed.

For example, the image data selection unit 33 selects the thinned image data so that the plurality of pieces of thinned image data stored in the image data storage unit 32 are evenly selected, or selects the thinned image data corresponding to human-readable information or a product code when the thinned image is associated with the human-readable information or the product code in advance.

The method of selecting the image data selection unit 33 is not limited to the above-mentioned method but may be appropriately changed. Various selection methods may be employed.

Further, a single piece of thinned image data may be stored in the image data storage unit 32, and the same thinned image data may be always selected by the image data selection unit 33.

The human-readable information decision unit 35 includes a numeric keypad, a function key, and a barcode reader, and receives input information such as an input of product specifying information (product code) for specifying a product and an input of the quantity of products.

Products sold in a shop are each given with a product code of, for example, a barcode. The printer 3 stores attached information on the product such as a price of a product, a product name, and human-readable information superimposed on a digital watermark by associating the attached information with the product codes. For this reason, when a checkout clerk inputs the product code and the quantity of products from the human-readable information decision unit 35, the printer 3 can perform checkout calculation.

Specifically, the human-readable information decision unit 35 generates items (print contents) to be printed on a receipt based on the inputted product code and quantity of products, the price stored in association with the product code, and the like. The print contents contain a product name, a quantity of products, a unit cost of products, a total amount of the products related to checkout, a time and date of checkout, a shop name, and a logo. The human-readable information decision unit 35 provides the print contents to the print information generation unit 34.

Further, the human-readable information decision unit 35 provides the product codes to the image data selection unit 33. Upon reception of the product code, the image data selection unit 33 selects one thinned image from the image data storage unit 32.

Further, the human-readable information decision unit 35 receives the product codes and the human-readable information in advance, and stores the product codes and the human-readable information associated with each other. Upon accepting the product code, the human-readable information decision unit 35 decides the human-readable information corresponding to the product code, and provides the human-readable information to the human-readable information analysis unit 36.

The human-readable information analysis unit 36 analyzes the human-readable information provided from the human-readable information decision unit 35. For example, the human-readable information analysis unit 36 discriminates whether the human-readable information is a character or an image. In a case where the human-readable information is a character, the human-readable information analysis unit 36 discriminates a font type of the character, a size of the character, and a size of the entire human-readable information. The human-readable information analysis unit 36 provides the human-readable information and analysis results to the human-readable information processing unit 37.

Upon accepting the human-readable information and the analysis results, the human-readable information processing unit 37 judges whether or not the human-readable information is to be processed based on the analysis results.

For example, in a case where the analysis results show that the human-readable information is an image, the human-readable information processing unit 37 judges that the human-readable information need not be processed, and provides the human-readable information to the print information generation unit 34 without processing the human-readable information.

In a case where the analysis results show that the human-readable information is a character and a font type of the character is Ming-cho type or cursive writing, the human-readable information processing unit 37 judges that the human-readable information is required to be processed since the human-readable information is hardly visible, processes the human-readable information, and provides the processed human-readable information to the print information generation unit 34.

Further, in a case where the analysis results show that the human-readable information is a character and the size of the character is smaller than the predetermined size, the human-readable information processing unit 37 judges that the human-readable information is required to be processed since the human-readable information is hardly visible, processes the human-readable information, and provides the processed human-readable information to the print information generation unit 34.

Further, in a case where the analysis results show that the human-readable information is a character and the size of the entire human-readable information is equal to or smaller than the predetermined ratio of the size of the information preset for the thinned image, the human-readable information processing unit 37 judges that the human-readable information is required to be processed since the human-readable information is hardly visible, processes the human-readable information, and provides the processed human-readable information to the print information generation unit 34.

Criteria for judgment of the human-readable information processing unit 37 are not limited to the above-mentioned criteria, but may be appropriately changed.

The method of processing the human-readable information may be, for example, processing of adding void portions to the outline of the human-readable information, but is not limited thereto. Alternatively, any processing method may be employed.

The print information generation unit 34 obtains the thinned image data selected by the image data selection unit 33, receives the print contents generated by the human-readable information decision unit 35, and further receives the human-readable information from the human-readable information processing unit 37.

The print information generation unit 34, for example, arranges the human-readable information accepted from the human-readable information processing unit 37 in a region of a part of the thinned image data obtained from the image data selection unit 33, to thereby generate print information.

The arrangement of the human-readable information is performed by writing the human-readable information over the thinned image data. As a result, the information provided to a portion on which the human-readable information is printed is replaced with the human-readable information.

For this reason, the information on the thinned image data provided to the region on which the human-readable information is printed is lost, but the information can be restored to such a degree that an ID pattern can be checked against an original image of the ID pattern based on the portion remaining as the background.

Experimental results show that the ID pattern can be restored even when about 50% in area of the thinned image is lost. Accordingly, the print information generation unit 34 sets the area of the region on which the human-readable information is to be printed to equal to or lower than 50% in area of the thinned image.

The print information generation unit 34 has a function of independently adjusting each gradation of the thinned image and the human-readable information.

This is because when the thinned image is printed in a deep color, the human-readable information becomes hardly visible. Accordingly, the thinned image is made light in color tone within a range in which the ID pattern can be reproduced.

The print information generation unit 34 can also adjust each gradation of the human-readable information and the other print contents to be made appropriate for visual observation.

A user (checkout clerk) of the printer 3 operates the printer 3 using a gradation adjustment screen or the like displayed on the display device of the printer 3, thereby making it possible to perform fine adjustment of each gradation of the thinned image, the human-readable information, and the print contents.

Then, the gradation information set by the user is recorded as print information by the print information generation unit 34, and the printing unit 38 prints a receipt according to the set gradation.

The printing unit 38 performs printing on the print medium based on the print information generated by the print information generation unit 34.

The print medium is, for example, roll paper which is wound in a roll shape and loaded, and the printing unit 38 performs printing on the print medium by coloring dots having a monochrome color. The printing unit 38 includes a cutter, and cuts the print medium along appropriate sections upon completion of the printing.

As a printing method, various methods including an impact method and a non-impact method can be used.

As the impact method, there is a method of, for example, transferring ink of an ink ribbon by pushing a pin of a printhead against a print medium. In this method, dots of the ink are distributed on the print medium based on the print information, thereby printing the thinned image and the print contents.

As the non-impact method, there is a method of, for example, a thermal transfer method. In this method, ink for thermal recording paper contained in a print medium is colored by Joule heat generated through energization of a thermal head. The thermal transfer method is used in many cases for an apparatus having a simple printing function, such as a cash register, because the printing device is reduced in size and weight and is free from maintenance. Other examples of the other non-impact method include a method employing an inkjet process and a method using a laser beam.

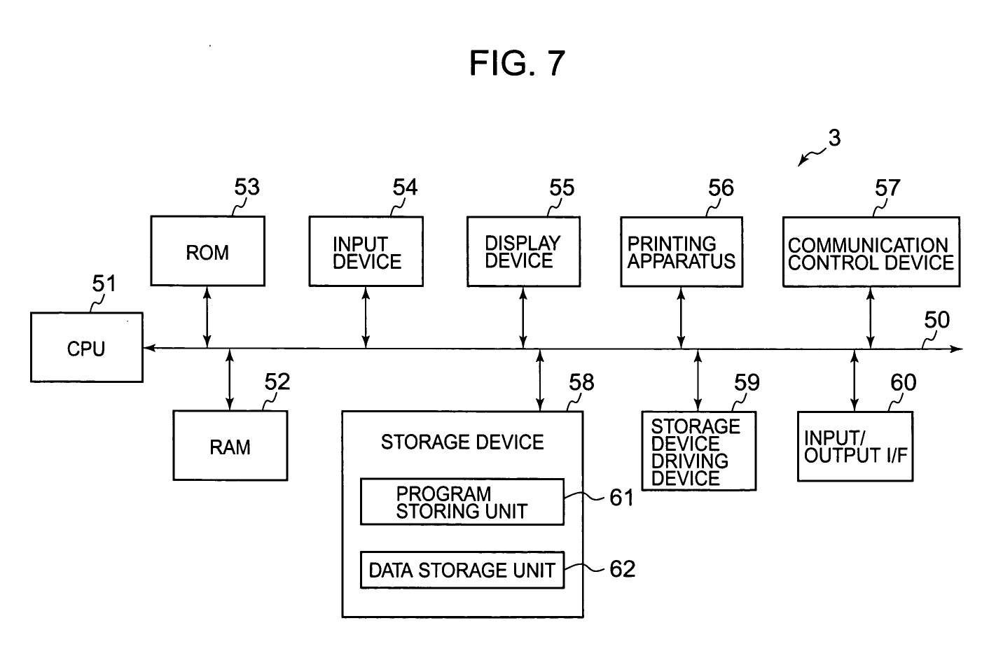

FIG. 7 is a block diagram showing an example of a hardware configuration of the printer 3 will be described.

In the printer 3, hardware such as a central processing unit (CPU) 51, a random access memory (RAM) 52, a read only memory (ROM) 53, an input device 54, a display device 55, a printing device 56, a communication control device 57, a storage device 58, a storage medium driving device 59, and an input/output I/F 60 serving as an interface for input/output are connected to each other via a bus line 50.

The CPU 51 performs, for example, control of each component performing various calculation processing and information processing, and included in the printer 3 according to the predetermined program. The CPU 51 performs not only checkout calculation processing, but also processing of, for example, receiving the thinned image data from the URL server 2 to store the data, and synthesizing the thinned image data and the print contents to print the synthesized data on a receipt.

The ROM 53 stores fundamental programs or data for activating the printer 3, and the RAM 52 provides a working area for activating the CPU 51.

The input device 54 is hardware constituting the human-readable information decision unit 35, and includes a numeric keypad, a function key, a barcode reader, and other input devices.

The display device 55 displays character information or image information, and displays, for example, a total amount of purchase obtained as a result of checkout processing to a customer. The display device 55 is composed of, for example, a liquid crystal display, a plasma display, and other display devices.

The communication control device 57 is a functioning unit for connecting the printer 3 to the Internet. The printer 3 can communicate with the URL server 2 and the other server devices through the communication control device 57. In a case where a sales management server installed in a head office performs sales management, the printer 3 is capable of connecting to the sales management server through the communication control device 57 and transmitting the sales data and the like.

The printing device 56 is hardware constituting the printing unit 38.

The storage medium driving device 59 is a functional part for driving a storage medium detachably mounted and reading/writing data. Examples of a readable/writable recording medium include a flexible disk, a magnet-optical disk, a semiconductor storage device, magnetic tape, and paper tape. Example of a read-only recording medium include an optical disk such as a CD-ROM.

The printer 3 can install a program from the recording medium mounted to the storage medium driving device 59. The printer 3 also can read the thinned image stored in the storage medium, store the thinned image in the image data storage unit 32, and write the accumulated checkout processing data to the storage medium.

The storage device 58 is, for example, a readable/writable storage device with a large capacity which is constituted of a hard disk or the like. The storage device 58 includes a program storing unit 61 which stores programs and a data storage unit 62 which stores data.

The program storing unit 61 stores various programs such as an operating system (hereinafter, referred to as “OS”), a communication program, and a checkout processing program such that the programs can be executed by the CPU 51.

The OS functions as a program for causing the CPU 51 to exert a fundamental function of operating the printer 3 such as management of input/output of a file and controlling of various functions.

The communication program is a program for causing the CPU 51 to exert a function of controlling the communication control device 57 and establishing communication via the Internet.

The checkout processing program is a program for causing the printer 3 to perform checkout processing including issuance of a receipt, and for causing the CPU 51 to exert functions such as selection processing of a thinned image, checkout processing, generation of print contents, generation of print information, and printing processing.

The data storage unit 62 stores the thinned image, the checkout processing data, and the like that have been downloaded from the URL server 2.

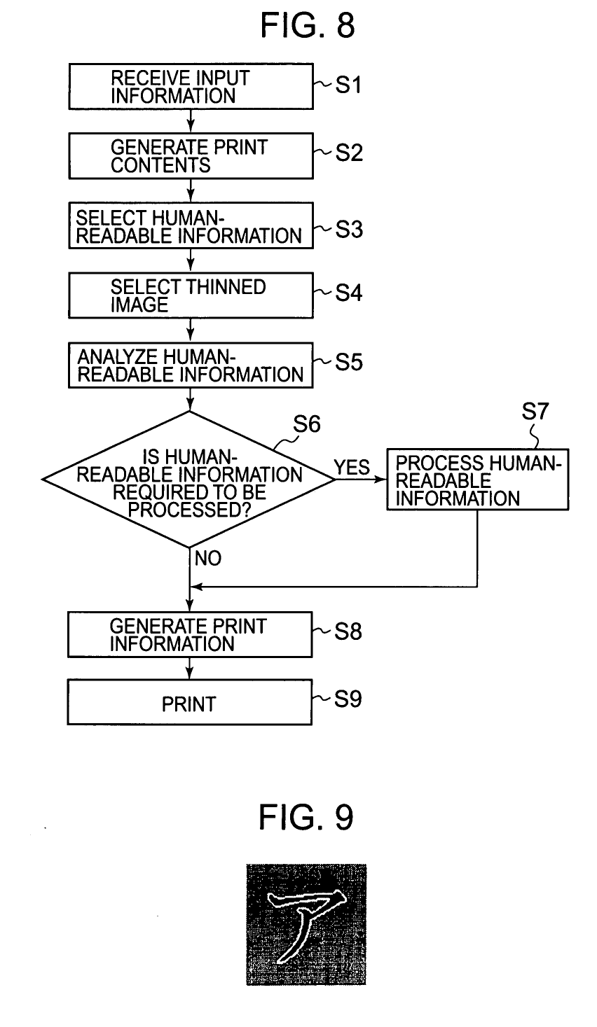

FIG. 8 is a flowchart for explaining a procedure for printing a receipt with the printer 3. It is assumed that the image data storage unit 32 stores the thinned image data.

First, the human-readable information decision unit 35 receives input information (Step S1). The input information contains a product code and a quantity of products.

Next, the human-readable information decision unit 35 generates information on print contents for specifying contents to be printed on a receipt, such as a product name, a quantity of items, a unit price, a total amount, a date and time of purchase, and a shop name, based on the input information, and provides the print contents to the print information generation unit 34 (Step S2).

Then, the human-readable information decision unit 35 selects the human-readable information based on the input information, and provides the human-readable information to the human-readable information analysis unit 36 (Step S3).

Then, the human-readable information decision unit 35 provides the input information to the image data selection unit 33. Upon accepting the input information, the image data selection unit 33 selects the thinned image data to be printed from the image data storage unit 32 (Step S4).

Then, the human-readable information analysis unit 36 analyzes the human-readable information provided from the human-readable information decision unit 35, and provides the analyzed human-readable information and analysis results to the human-readable information processing unit 37 (Step S5).

Then, the human-readable information processing unit 37 judges whether or not the human-readable information is required to be processed based on the analysis results (Step S6.).

When judging that the human-readable information is required to be processed, the human-readable information processing unit 37 processes the human-readable information so that the human-readable information can be viewed more easily, and provides the processed human-readable information to the print information generation unit 34 (Step S7).

FIG. 9 shows an example where the human-readable information processing unit 37 performs processing of adding void portions along with the outline of the human-readable information so that human-readable information [symbol] can be viewed more easily. In FIG. 9, the periphery of the void portion is colored so that the void portion is clearly viewed, but the human-readable information includes no colored portion.

On the other hand, when judging that the human-readable information is not required to be processed, the human-readable information processing unit 37 provides the human-readable information to the information generation unit 34.

Then, the print information generation unit 34, for example, obtains the thinned image selected by the image data selection unit 33, receives the print contents generated by the human-readable information decision unit 35, receives the human-readable information from the human-readable information processing unit 37, and arranges the human-readable information accepted from the human-readable information processing unit 37 in a part of the region of the thinned image obtained from the image data selection unit 33, to thereby generate print information (Step S8).

Then, the printing unit 38 performs printing on a print medium based on the print information generated by the print information generation unit 34, and issues a receipt.

As described above, the printer 3 can print, on a receipt, the human-readable information with the thinned image as a background in association with the checkout processing.

As a result, the receipt 4 in which the ID pattern shown in FIG. 5 is embedded is generated. FIG. 10 is an explanatory diagram showing a printed result obtained such that the human-readable information of characters representing [symbol] which is added with void portions correspondingly to the outline of the font, is superimposed on the thinned image before printing.

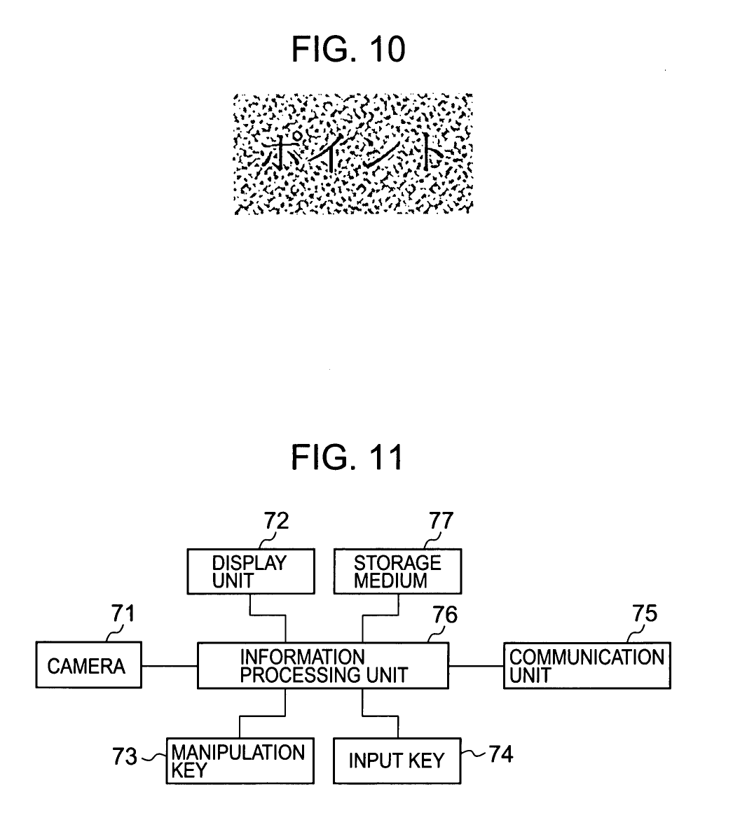

Next, the cellular phone 5 will be described. The cellular phone 5 has a camera function and an Internet connection function. FIG. 11 is a block diagram showing the cellular phone 5.

In FIG. 11, the cellular phone 5 includes a camera 71, a display unit 72, an manipulation key 73, an input key 74, a communication unit 75, an information processing unit 76, and a storage medium 77.

The information processing unit 76 includes a CPU, a ROM, and a RAM, and the storage medium 77 is a readable/writable recording medium which is constituted of, for example, an electrical erasable and programmable ROM (EEPROM) and stores various programs and data.

The CPU of the cellular phone 5 (hereinafter, referred to simply as “CPU”) performs various kinds of information processing according to the program stored in the ROM or the other storage media. The RAM provides a working memory for the CPU to, for example, obtain photographed image data of the receipt 4, transmit the obtained photographed image data to the URL server 2, and receive a URL from the URL server 2 to connect to the service server 6.

The storage medium 77 stores an application program for taking an image of the receipt 4 and connecting to the service server 6.

The CPU executes the application program to thereby realize the functions of connecting to the URL server 2 to transmit thereto the photographed image data of the receipt 4, receiving the URL transmitted by the URL server 2 based on the transmitted photographed image data, and connecting to the website designated by the information on the URL using the received URL information.

The storage device 77 also stores a browser program, and the CPU can exert a browser function using the browser program.

The camera 71 is an example of an image taking unit, and includes an optical system composed of a lens and the like, and a charge coupled device (CCD) for converting an image of an object projected by the optical system into digital data.

When a customer takes an image of the receipt 4 with the camera 71, the photographed image data of the receipt is generated by the CPU. In a portion indicating the thinned image in the photographed image data, dots are thinned out. The CPU smoothes the photographed image data so that a state of the image where the dots are thinned out is changed into a state of the image before the dots are thinned out. For example, the CPU removes high frequency components of the frequency components corresponding to thinning intervals of the dots of the photographed image data, to thereby smooth the photographed image data.

The display unit 72 is constituted of, for example, a liquid crystal display, and displays information on telephone calls including telephone numbers, and further displays various web pages transmitted from web servers via the Internet in a browser.

The manipulation key 73 is a key for, for example, selecting an icon displayed on the display unit 72 or selecting a link so that the customer can perform various screen operations on a screen displayed on the display unit 72.

The input key 74 is a key for inputting numbers, characters, symbols, or the like to the cellular phone 5.

By using the cellular phone 5 thus structured, it is possible to take an image of a receipt, analyze the thinned image of the receipt, and to be automatically connected to a website designated based on the analysis results.

In this embodiment, the URL server 2 subjects the photographed image data to Fourier transform and extracts the ID pattern, but the cellular phone 5 may alternatively perform the processing and transmit the extracted IF pattern to the URL server 2 from the cellular phone 5.

In this case, in the application program stored in the storage medium 77, information necessary for the CPU to perform processing of subjecting the photographed image data to Fourier transform and extracting the ID pattern from the data subjected to the Fourier transform is described.

Further, in this embodiment, the cellular phone 5 performs processing such as taking an image of a receipt, but other types of terminals may realize the similar functions. For example, a personal digital assistant (PDA), a game machine, and a personal computer which have a camera and the application mounted thereon may realize the functions.

Next, the service server 6 will be described. The service server 6 is a web server which runs a website designated by a URL. An administrator of the website can provide, on the website, a character, a still image, a moving image, sound, link information, and the like to a terminal device. The hardware configuration of the service server 6 is basically similar to that of the URL server 2.

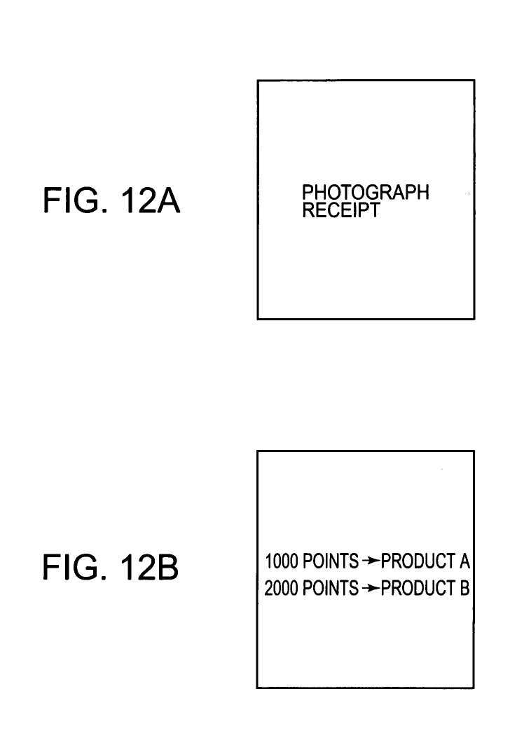

FIG. 12 is a diagram for explaining an example of a screen displayed on the display unit 72 of the cellular phone 5.

FIG. 12A shows an example of a screen displayed on the display unit 72 of the cellular phone 5 when the application is started by the cellular phone 5.

In the example of FIG. 12A, the display unit displays that “Photograph a receipt.” which prompts the customer to take an image of the receipt. The customer takes an image of the receipt received at the checkout counter in response to the instruction.

FIG. 12B shows an example of a screen displayed on the display unit of the cellular phone 5 when the cellular phone 5 is connected to the website run by the service server 6.

After the customer has taken the image of the receipt, the cellular phone 5 performs a series of processing of transmitting the photographed image data to the URL server 2, connecting to the service server 6 using the URL sent from the URL server 2, interpreting a top page transmitted from the service server 6 by a browser, and displaying the interpreted top page.

On the top screen, information indicating which items can be obtained in exchange for how many accumulated points.

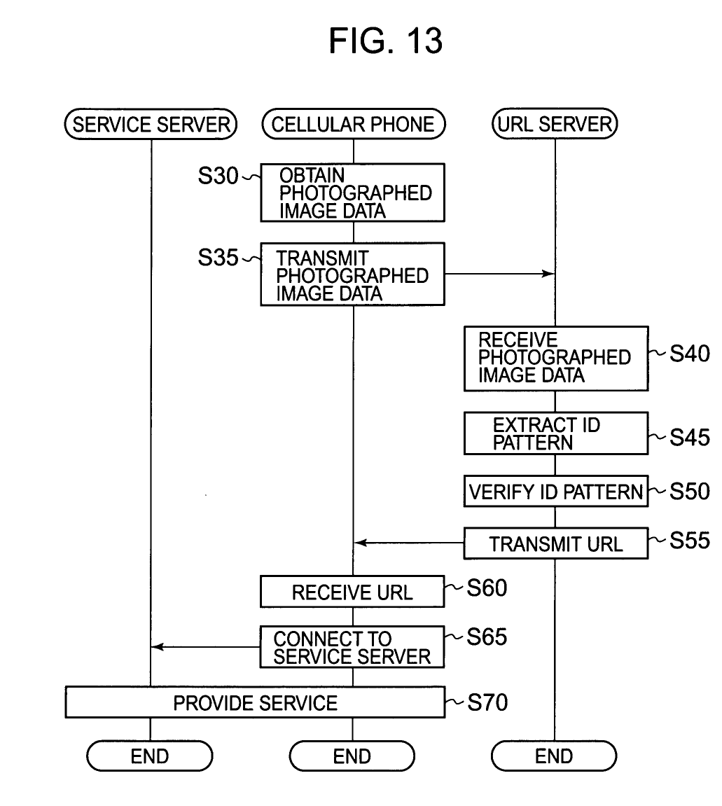

FIG. 13 is a flowchart for explaining a procedure of connecting the cellular phone 5 to the service server 6.

First, the customer receives a receipt issued in the payment of a purchase in a shop. Then, the application of the cellular phone 5 is started to take an image of the receipt by the cellular phone 5. As a result, the cellular phone 5 obtains the photographed image data of the receipt (Step S30).

Then, the cellular phone 5 is connected to the service server 2, and transmits the obtained photographed image data to the URL server 2 (Step S35).

The URL server 2 receives the photographed image data from the cellular phone 5 (Step S40).

Then, the URL server 2 subjects the photographed image data to Fourier transform, and extracts the ID pattern from the data subjected to Fourier transform (Step S45).

Further, the URL server 2 retrieves the ID pattern by checking the extracted ID pattern against the ID pattern registered in the ID database in advance, and specifies the ID pattern contained in the photographed image data (Step S50).

Upon specifying the ID pattern, the URL server 2 obtains data of the URL associated with the ID pattern in the ID database and transmits the obtained data to the cellular phone 5 (Step S55).

The cellular phone 5 receives the data of the URL from the URL server 2 (Step S60), and is connected to the service server 6 by using the data (Step S65).

The service server 6 accepts connection from the cellular phone 5, transmits top page screen data to the cellular phone 5, and continuously provides services to the cellular phone 5 (Step S70).

According to the above-mentioned embodiment, the following effects can be obtained.

It is possible to decode digital watermarks at a high ratio while ensuring visibility of human-readable information even when the human-readable information is superimposed on the digital watermarks or thinned digital watermarks before printing.

Further, according to the forms of the human-readable information, it becomes possible to process human-readable information. For this reason, for example, the human-readable information, which is hardly visible when the human-readable information is superimposed on the digital watermark image, can be printed as an image by processing the data into a form which is likely to be visible even when the human-readable information is superimposed on the digital watermark image.

In the above-mentioned embodiment, illustrated structures are only examples and the present invention is not limited thereto.

For example, as a method of embedding the ID pattern using a frequency domain, Fourier transform is employed in this embodiment, but the Fourier transform is only an example. As other examples of transform, there are given discrete cosine transform (DCT) and wavelet transform.

Further, in this embodiment, a thinned image is printed on a receipt issued in payment of a purchase in a shop or the like as an example, but applications for the thinned image is not limited thereto. For example, the thinned image can be applied to various printed materials such as a magazine, a newspaper, and a poster. The thinned image can be displayed not only on the printed materials, but also on a display device such as a display.

Further, in this embodiment, the ID pattern is associated with a URL as an example, and information to be associated with the ID pattern may include various pieces of information such as an image, sound, and a character.

For example, a quiz is printed on the thinned image as human-readable information, and the ID pattern is associated with the answer of the quiz, and the thinned image is photographed, thereby making it possible to view the answer to the quiz.

The printing unit 38 may print the thinned image in a color different from that used for the human-readable information. In this case, it is possible to prevent the human-readable information from being hardly visible due to the digital watermark information.

Further, in this embodiment, the URL server 2 generates the thinned image data, but the URL server 2 may transmit the binarized ID background image to the printer 3, and the printer 3 may generate the thinned image data from the ID background image.

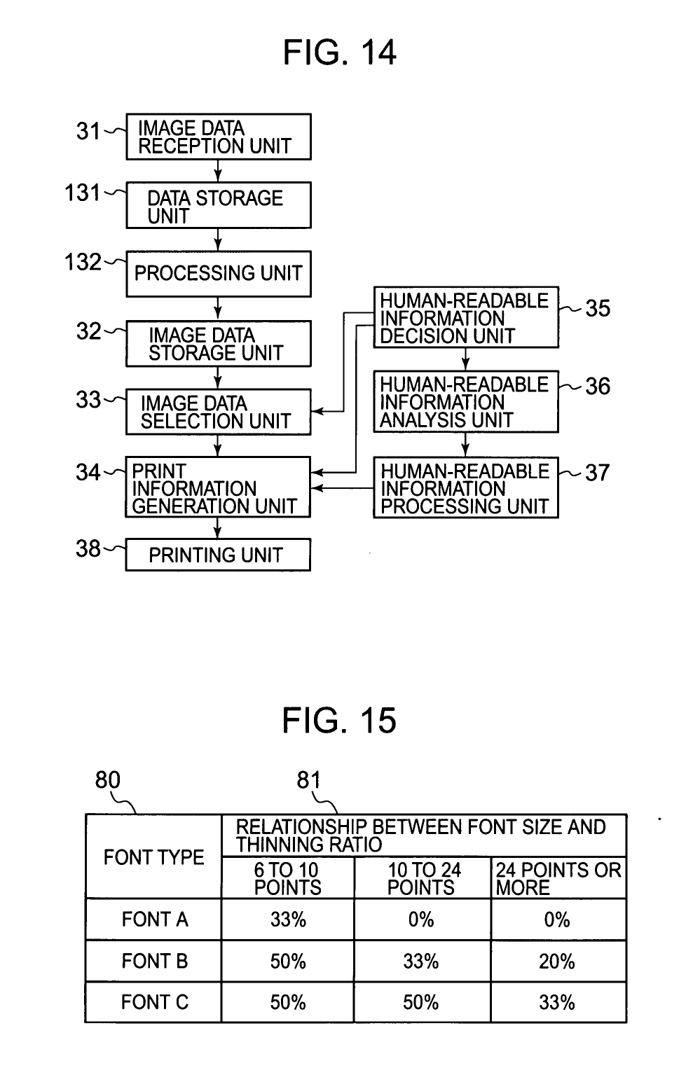

FIG. 14 is a block diagram showing an example of a printer 30 for generating the thinned image. In FIG. 14, components identical with those of FIG. 6 are denoted by the same reference numerals.

In FIG. 14, the printer 30 includes the image data reception unit 31, a data storage unit 131, a processing unit 132, the image data storage unit 32, the image data selection unit 33, the print information generation unit 34, the print information decision unit 35, the human-readable information analysis unit 36, and the human-readable information processing unit 37.

The image data reception unit 31 receives the binarized ID background image data transmitted from the URL server 2, and stores the ID background image data in the data storage unit 131.

The processing unit 132 has functions similar to those of the processing unit 23 shown in FIG. 3. Specifically, the processing unit 132 reads the ID background image 12 stored in the data storage unit 131, and processes a part of a plurality of dots in an on state into dots in an off state so that at least dots that are successively arranged in a vertical or horizontal direction and are in the on state are not present in the ID background image 12, to thereby generate thinned-out digital watermark information.

For example, the processing unit 132 switches the state of the successive dots that are in the tuned-on state and in the ID background image, alternately between the on state and the off state, so that the dots in the on states make a checkered pattern, in the same manner as in the processing unit 23.

The processing performed by the processing unit 132 is not limited to the above-mentioned processing, but may be appropriately changed. For example, the processing unit 132 may process the ID background image so that two dots that are in the off state are present between the adjacent dots that are in the on state. Thus, the image data is processed.

Further, the processing unit 132 may perform processing according to a list shown in FIG. 15. In this case, the processing unit 132 receives human-readable information containing font information, and changes thinning-out processing for the background image based on the human-readable information.

FIG. 15 is a list showing a relationship between the human-readable information and a thinning ratio of the background image. Specifically, FIG. 15 shows conditions in a case where the human-readable information is made visible by changing the thinning ratio of the background image without processing the human-readable information. The conditions are stored in, for example, the processing unit 132.

FIG. 15 shows a font type 80 and a relationship 81 between a font size and a thinning ratio.

In FIG. 15, with respect to a thickness of an original character, a font B is thicker than a font C, and a font A is thicker than the font B. The larger the thickness of the character is, the more the thinning ratio of the background image can be reduced, because the character having a larger thickness is hardly affected by the background image when the character is superimposed on the background image.

For example, the font A is thickest in FIG. 15 and is a most visible font, and thinning-out of the background image is not required when the font size of the character is 24 points or larger. In addition, even when the point size is 10 to 24 points, the thinning ratio of the background image can be reduced to 0%.

The font B is originally thinner than the font A, and can be hardly discriminated when the font B is superimposed on the background image. Accordingly, even when the font size thereof is 24 points or larger, the thinning ratio of the background image is set to 20%, and the background image is required to be thinned out to a certain extent. When the font size is 10 to 24 points, the background image is required to be thinned out at a much higher thinning ratio of 33%, and when the font size is 10 points or smaller, the background image is required to be thinned out at the thinning ratio of 50%. In this example, the font having a size of less than 6 points becomes extremely small when the font is printed, so the font is not used.

The font C is much thinner than the font B. When the font size thereof is 24 points or larger, the background image is required to be thinned out at the thinning ratio of 33%; when the font size is 10 to 24 points, at the thinning ratio of 50%; and when the font size is 10 points or smaller, at the thinning ratio of 50%.

As described above, the processing unit 132 changes the thinning ratio of the background image depending on the various fonts, thereby making it possible to discriminate the human-readable information more easily when the human-readable information is superimposed on the background image.

To the contrary, when fixing the thinning ratio, the processing unit 132 can decide the relationship between the font type and the font size. For example, it is assumed that, at the thinning ratio of 33%, the font A can employ every font size, the font B cannot employ a font size of 10 points or smaller, and the font C can only employ a font size of 24 points or larger. In the case where the thinning ratio is fixed, the font size to be employed is set to a minimum font size appropriate for the case, thereby making it possible to select the font size.

As described above, by programming the relationship between the font and the thinning ratio in the processing unit 132 as a predetermined relationship, when the human-readable information is superimposed on the background information before printing, the processing unit 132 can perform printing by processing the human-readable information or the background image to perform printing so that the human-readable information can be discriminated.

As an example of a simple method of thinning out dots, processing is performed such that one dot of a pair of adjacent dots in the on state is turned off, to thereby establish a thinning ratio of about 50%. Further, processing is performed such that one dot of a set of adjacent three dots in the on state is turned off, to thereby establish a thinning ratio of about 33%.

The processing unit 132 stores the thinned image in the image data storage unit 32. The following operations are similar to those of the printer 3.

The processing unit 23 shown in FIG. 3 may perform processing based on the list shown in FIG. 15. In this case, the processing unit 23 receives the font type of the human-readable information from the printer 3, and then executes thinning-out processing for the background image according to the font type.

Further, in the above-mentioned embodiments, characters are mainly used as an example of the human-readable information, but the human-readable information may be an image of a character such as an animal.

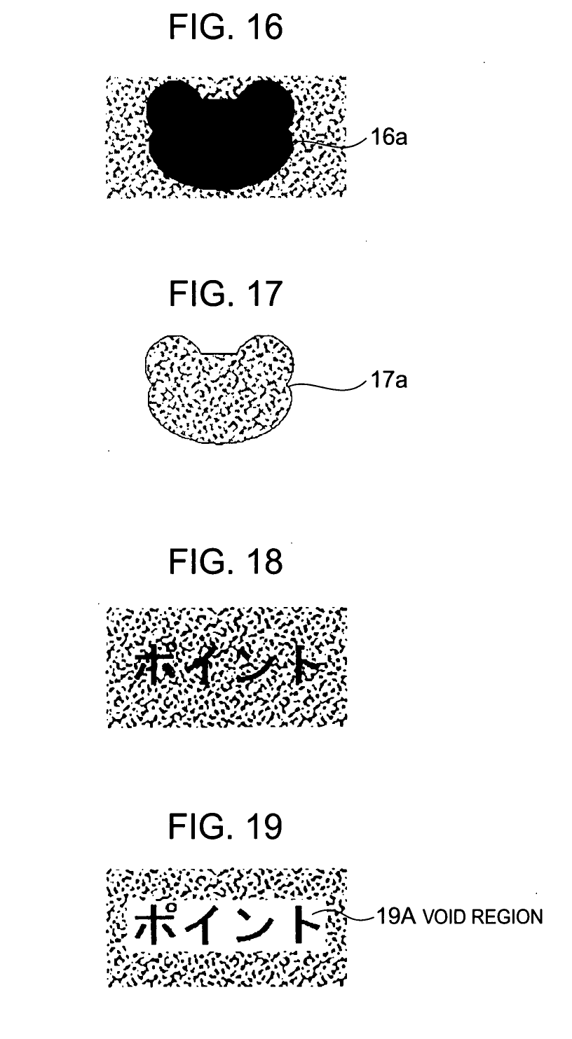

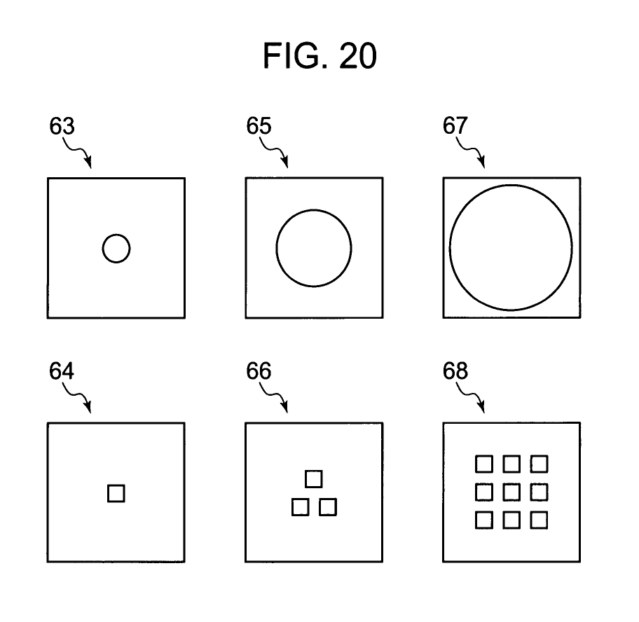

FIGS. 16 and 17 are diagrams for explaining a case where an image is used as the human-readable information.

In FIG. 16, an image 16a representing a shadow of an animal is used as the human-readable information, and in FIG. 17, an image 17a representing a clipped face portion of the animal is used as the human-readable information.

What is claimed is:

1. A printing system, comprising:
a transmission device for transmitting digital watermark information; and
a printer for printing the digital watermark information transmitted from the transmission device and human-readable information including one of a character and an image such that the human-readable information is superimposed on the digital watermark information, wherein:
the transmission device comprises:
a conversion unit for converting predetermined information into digital watermark information represented by a plurality of dots that are arranged in a matrix manner and are in an on state;
a processing unit for generating thinned-out digital watermark information by processing a part of the plurality of dots in the on state into dots in an off state so that at least dots that are successively arranged in a vertical or horizontal direction and are in the on state are not present in the digital watermark information converted by the conversion unit; and
a transmission unit for transmitting the thinned-out digital watermark information generated in the processing unit to the printer; and
the printer comprises:
a reception unit for receiving the thinned-out digital watermark information from the transmission unit;
a storage unit for storing the thinned-out digital watermark information received by the reception unit;
an acceptance unit for accepting the human-readable information; and
a printing execution unit for printing the thinned-out digital watermark information stored in the storage unit and the human-readable information accepted by the acceptance unit such that the human-readable information is superimposed on the thinned-out digital watermark information.

2. A printing system according to claim 1, wherein the printing execution unit prints the thinned-out digital watermark information using a color different from that used for the human-readable information.

3. A printing system according to claim 1, wherein the printing execution unit comprises:
an analysis unit for analyzing the human-readable information;
a human-readable information processing unit for processing the human-readable information based on analysis results of the analysis unit; and
a printing unit for printing the human-readable information processed in the human-readable information processing unit and the thinned-out digital watermark information stored in the storage unit such that the human-readable information is superimposed on the thinned-out digital watermark information.

4. A printer for printing digital watermark information and human-readable information including one of a character and an image such that the human-readable information is superimposed on the digital watermark information, comprising:
a data storage unit for storing digital watermark information represented by a plurality of dots in an on state among dots arranged in a matrix manner;
a processing unit for generating thinned-out digital watermark information by processing a part of the plurality of dots in the on state into dots in an off state so that at least dots that are successively arranged in a vertical or horizontal direction and are in the on state are not present in the digital watermark information stored in the data storage unit;
a storage unit for storing the thinned-out digital watermark information generated in the processing unit;
an acceptance unit for accepting the human-readable information; and
a printing execution unit for printing the thinned-out digital watermark information stored in the storage unit and the human-readable information accepted by the acceptance unit such that the human-readable information is superimposed on the thinned-out digital watermark information.

5. A printer according to claim 4, wherein the printing execution unit prints the thinned-out digital watermark information using a color different from that used for the human-readable information.

6. A printer according to claim 4, wherein the printing execution unit comprises:
an analysis unit for analyzing the human-readable information;
a human-readable information processing unit for processing the human-readable information based on analysis results of the analysis unit; and
a printing unit for printing the human-readable information processed by the human-readable information processing unit and the thinned-out digital watermark information stored in the storage unit such that the human-readable information is superimposed on the thinned-out digital watermark information.

7. A printing method for a printing system including a transmission device for transmitting digital watermark information and a printer for printing the digital watermark information transmitted from the transmission device and human-readable information including one of a character and an image such that the human-readable information is superimposed on the digital watermark information, the method comprising:
a converting step of converting, by the transmission device, predetermined information into digital watermark information represented by a plurality of dots that are arranged in a matrix manner and are in an on state;
a processing step of generating, by the transmission device, thinned-out digital watermark information by processing a part of the plurality of dots in the on state into dots in an off state so that at least dots that are successively arranged in a vertical or horizontal direction and are in the on state are not present in the digital watermark information;
a transmitting step of transmitting, by the transmission device, the thinned-out digital watermark information to the printer;
a receiving step of receiving, by the printer, the thinned-out digital watermark information from the transmission unit;
a storing step of storing, by the printer, the received thinned-out digital watermark information;
an accepting step of accepting, by the printer, the human-readable information; and
a printing execution step of printing, by the printer, the stored thinned-out digital watermark information and the accepted human-readable information such that the human-readable information is superimposed on the thinned-out digital watermark information.

8. A printing method for a printer, including printing digital watermark information and human-readable information including one of a character and an image such that the human-readable information is superimposed on the digital watermark information, the method comprising:
a data storing step of storing digital watermark information represented by a plurality of dots in an on state among dots arranged in a matrix manner;
a processing step of processing a part of the plurality of dots in the on state into dots in an off state so that at least dots that are successively arranged in a vertical or horizontal direction and are in the on state are not present in the digital watermark information, to produce thinned-out digital watermark information;
a storing step of storing the thinned-out digital watermark information;
an accepting step of accepting the human-readable information; and
a printing execution step of printing the stored thinned-out digital watermark information and the accepted human-readable information such that the human-readable information is superimposed on the thinned-out digital watermark information.

9. A reader for reading digital watermark information, comprising:
an image taking unit for taking an image of the digital watermark information and outputting digital watermark image information;
a smoothing unit for smoothing the digital watermark image information outputted from the image taking unit; and
an output unit for outputting the digital watermark image information smoothed by the smoothing unit.

10. A reading method for a reader for reading digital watermark information, comprising:
an image taking step of taking an image of the digital watermark information and outputting digital watermark image information;
a smoothing step of smoothing the digital watermark image information; and
an outputting step of outputting the smoothed digital watermark image information.
